(19) United States
(12) Patent Application Publication
(10) Pub. No.: US 2025/0008195 A1
(43) Pub. Date: Jan. 2, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: HIDEAKI WATANABE, TOKYO (JP)

(21) Appl. No.: 18/707,185

(22) PCT Filed: Sep. 26, 2022
(86) PCT No.: PCT/JP2022/035566

§ 371 Date: May 3, 2024

(30) Foreign Application Priority Data
Nov. 11, 2021 (JP) 2021-184070

(51) Int. Cl. H04N 21/81; G06F 3/16; H04N 21/439; H04N 21/44; H04N 21/442

(52) U.S. Cl. CPC H04N 21/8113; G06F 3/165; H04N 21/4394; H04N 21/44008; H04N 21/44218

(57) ABSTRACT

[Problem] Provided is a new and improved information processing apparatus capable of further improving a viewing experience of a user in a content including a sound. [Solution] An information processing apparatus includes an information output unit configured to output sound control information on a basis of an analysis result of first time-series data included in content data and an analysis result of second time-series data indicating a situation of a user, in which the sound control information includes information for controlling sound image localization of a voice of another user output to a user terminal used by the user or a sound included in the content data.

### TECHNICAL FIELD

The present disclosure relates to an information processing apparatus, an information processing method, and a program.

### BACKGROUND ART

In recent years, live distribution of distributing a video and an audio of a state where a music live show, an online game, or the like is performed to a user terminal in real time has been actively performed. Alternatively, video distribution of distributing the video and the audio recorded in advance to a user terminal is also actively performed.

Furthermore, a voice chat service in which a plurality of users viewing a content such as the above-described live distribution or video distribution enjoy the same content while talking with each other has also become widespread. By talking while viewing the same content, each user can obtain a feeling of sharing the same experience while being in different places.

In a case where the users talk to each other while viewing the distribution content as described above, each user simultaneously listens to sounds generated from a plurality of sound sources, such as a sound included in the content and a talk voice. Therefore, a technique for making it easy for a user to hear each sound even in a state of simultaneously listening to a sound included in content and a talk voice has been studied.

For example, Patent Document 1 discloses a technique for clearly listening to a call sound by spatially separately performing localization and separation processing on a sound of an audio content and a talk voice in a case where an incoming call is detected during reproduction of the audio content.

### CITATION LIST

### Patent Document

Patent Document 1: Japanese Patent Application Laid-Open No. 2006-074572

### SUMMARY OF THE INVENTION

### Problems to be Solved by the Invention

However, it is desirable to further improve the viewing experience of the user in a content including a sound, such as live distribution or video distribution.

Therefore, the present disclosure has been made in view of the above problem, and an object of the present disclosure is to provide a new and improved information processing apparatus capable of further improving the viewing experience of the user in the content including a sound.

### Solutions to Problems

In order to solve the above problem, according to an aspect of the present disclosure, there is provided an information processing apparatus including an information output unit configured to output sound control information on a basis of an analysis result of first time-series data included in content data and an analysis result of second time-series data indicating a situation of a user, in which the sound control information includes information for controlling sound image localization of a voice of another user output to a user terminal used by the user or a sound included in the content data.

Furthermore, in order to solve the above problem, according to another aspect of the present disclosure, there is provided an information processing method executed by a computer, the computer including outputting sound control information on a basis of an analysis result of first time-series data included in content data and an analysis result of second time-series data indicating a situation of a user, in which the sound control information includes information for controlling sound image localization of a voice of another user output to a user terminal used by the user or a sound included in the content data.

Furthermore, in order to solve the above problem, according to another aspect of the present disclosure, there is provided a program configured to cause a computer to function as an information processing apparatus including an information output unit configured to output sound control information on a basis of an analysis result of first time-series data included in content data and an analysis result of second time-series data indicating a situation of a user, in which the sound control information includes information for controlling sound image localization of a voice of another user output to a user terminal used by the user or a sound included in the content data.

### BRIEF DESCRIPTION OF DRAWINGS

FIG. 1 is a diagram explaining an outline of an information processing system 1 according to an embodiment of the present disclosure.

FIG. 2 is an explanatory diagram showing a functional configuration example of a user terminal 10 according to the present embodiment.

FIG. 3 is an explanatory diagram showing a functional configuration example of an information processing apparatus 20 according to the present embodiment.

FIG. 4 is an explanatory diagram for explaining a specific example of content analysis information generated by a content information analysis unit 252 according to the present embodiment.

FIG. 5 is an explanatory diagram for explaining a specific example of user analysis information generated by a user information analysis unit 254 according to the present embodiment.

FIG. 6 is an explanatory diagram for explaining a specific example of sound control information output by an information generation unit 256 according to the present embodiment.

FIG. 7 is a flowchart showing an operation example of the information processing apparatus 20 according to the present embodiment.

FIG. 8 is an explanatory diagram for explaining a specific example of sound control information output by the information generation unit 256 according to the present embodiment.

FIG. 9 is a block diagram showing a hardware configuration example of an information processing apparatus 900 that implements the information processing system 1 according to the embodiment of the present disclosure.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference numerals to avoid the description from being redundant.

In addition, in the present specification and drawings, there is a case in which a plurality of components having substantially the same functional configuration is distinguished from each other with different alphabets or numbers attached after the same reference sign. However, in a case where it is not necessary to particularly distinguish each of the plurality of components having substantially the same functional configuration, only the same reference numeral is attached to each of the plurality of components.

Note that the mode for carrying out the invention is described in the order of items described below.
1. Overview of information processing system according to embodiment of present disclosure
2. Functional configuration example according to present embodiment
2-1. Functional configuration example of user terminal 10
2-2. Functional configuration example of information processing apparatus 20
3. Operation processing example according to present embodiment
4. Modifications
5. Hardware configuration example
6. Conclusion

### 1. OVERVIEW OF INFORMATION PROCESSING SYSTEM ACCORDING TO EMBODIMENT OF PRESENT DISCLOSURE

An embodiment of the present disclosure relates to an information processing system that distributes data of a content including a sound such as a music live show to a user terminal and dynamically controls a sound output from the user terminal according to a situation of the content or a situation of the user. The information processing system is applied, for example, in a case where a user who is viewing a music live show by remote distribution views the same content while talking with another user in a remote place. According to the present embodiment, for example, while the user is talking with the another user, a sound output from the user terminal is controlled so that the user can easily hear a voice of the another user. Furthermore, while the sound is controlled, control of a sound according to the situation of the content is performed. For example, in a case where music is played in the content, the output sound is dynamically controlled in accordance with a video included in the content, a tune of the music, or a degree of excitement of the user. By performing the control as described above, it is possible to improve the viewing experience of the user who is viewing the content including a sound.

In the present embodiment, a live distribution of a music live show in which a video and a sound of a performer imaged at a live venue are provided to a user at a remote location in real time will be described as an example. The remote place means a place different from the place where the performer is. The content to be distributed is not limited to a music live show, and includes performance performed in front of an audience, such as manzai, a play, a dance, or an online game. Furthermore, the distributed content may be another content.

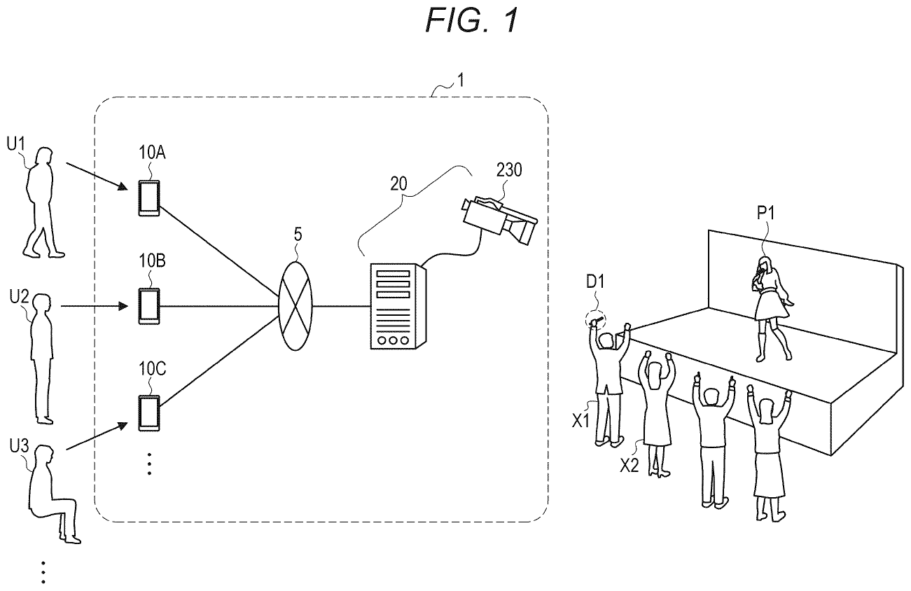

FIG. 1 is a diagram explaining an outline of an information processing system 1 according to the present embodiment. As shown in FIG. 1, the information processing system 1 according to the present embodiment includes a user terminal 10 and an information processing apparatus 20. The number of user terminals 10 may be plural, that is, at least one or more. As shown in FIG. 1, the user terminals 10 and the information processing apparatus 20 are configured to be communicable via a network 5.

The user terminal 10 is an information processing terminal used by a user U. The user terminal 10 is an information processing terminal including a single or a plurality of devices and including at least a function of outputting a video or a sound, a function of inputting a sound, and a sensor that detects a state or an action of the user.

The user terminal 10 receives content data from the information processing apparatus 20. Furthermore, in a case where the user U is talking with another user who is viewing the same content, the user terminal 10 receives voice data of the another user from the information processing apparatus 20.

Further, the user terminal 10 receives, from the information processing apparatus 20, sound control information which is information for performing output processing of a sound included in the content data and a voice of the another user. The user terminal 10 performs output processing of the sound included in the content data and the voice of the another user together with the video included in the content data according to the sound control information. With this configuration, the user U can enjoy the talk with the another user while viewing the content distributed by the user terminal 10 used by the user U.

Furthermore, the user terminal 10 detects a reaction shown while the user U is viewing the content, and transmits remote user information, which is information indicating the reaction, to the information processing apparatus 20. The remote user information includes a voice of the user U in a case where the user U is during talking with another user.

Note that the user terminal 10 may include a plurality of information processing terminals or may be a single information processing terminal. In the example shown in FIG. 1, the user terminal 10 is a smartphone, performs output processing of content data distributed from the information processing apparatus 20, and acquires a voice of the user by a built-in microphone. Furthermore, in the example shown in FIG. 1, the user terminal 10 images the user U with a built-in camera and detects the state or the action of the user U.

In addition to the smartphone shown in FIG. 1, the user terminal 10 may be configured by a single unit of various devices such as a non-transmissive head mounted display (HMD) covering the entire field of view of the user, a tablet terminal, a personal computer (PC), a projector, a game terminal, a television device, a wearable device, and a motion capture device, or a combination of the various devices.

In the example shown in FIG. 1, a user U1 uses a user terminal 10A. Similarly, a user U2 uses a user terminal 10B, and a user U3 uses a user terminal 10C. In addition, the users U1 to U3 view live distribution at different places. Alternatively, the users U1 to U3 may view the live distribution at the same place.

As shown in FIG. 1, the information processing apparatus 20 includes an imaging unit 230. Furthermore, the information processing apparatus 20 includes a sound input unit (not shown in FIG. 1). The information processing apparatus 20 acquires, by the imaging unit 230 and the sound input unit, a video and a sound of a state where performance is performed by a performer P1 at the live venue. The video and the sound are transmitted to the user terminal 10 as content data.

Furthermore, the information processing apparatus 20 detects, by the imaging unit 230 and the sound input unit, venue user information indicating a state or an action of a user X who is an audience viewing the performance at the live venue. The information processing apparatus 20 uses the venue user information as information indicating a reaction of the venue user to the performance for user information analysis described later. The venue user information can include, for example, information indicating cheer of the user X or movement of a device D1 such as a penlight gripped by the user X.

Furthermore, the information processing apparatus 20 receives, from the user terminal 10, remote user information indicating a state or an action of each of the users U who are viewing the content.

The information processing apparatus 20 has a content information analysis function of analyzing the video and the sound acquired by the imaging unit 230 and the sound input unit, and a user information analysis function of analyzing the remote user information and the venue user information. The information processing apparatus 20 generates and outputs sound control information indicating how to cause each of the user terminals 10 to perform output processing of the sound included in the content data or the voice of the user U on the basis of the result of the analysis. The sound control information is output for each of the plurality of user terminals 10.

The information processing apparatus 20 transmits the sound control information to the user terminal 10 together with the content data. With this configuration, the information processing apparatus 20 can cause the user terminal 10 to perform sound output control according to the analysis result of the content data, the remote user information, and the venue user information.

### 2. FUNCTIONAL CONFIGURATION EXAMPLE ACCORDING TO PRESENT EMBODIMENT

The outline of the information processing system 1 according to the embodiment of the present disclosure has been described above with reference to FIG. 1. Next, functional configuration examples of the user terminal 10 and the information processing apparatus 20 according to the present embodiment will be sequentially described in detail.

### <2-1. Functional Configuration Example of User Terminal 10>

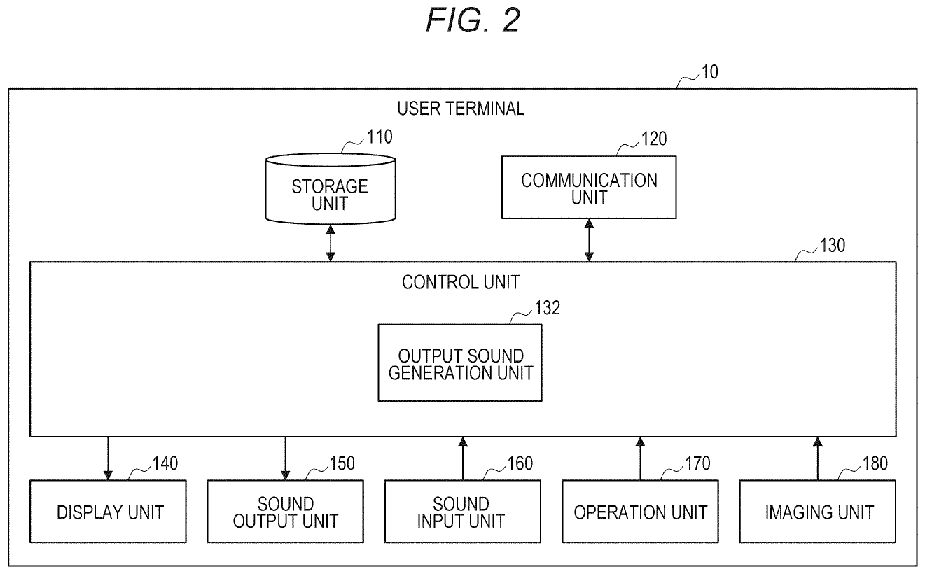

FIG. 2 is an explanatory diagram showing a functional configuration example of the user terminal 10 according to the present embodiment. As shown in FIG. 2, the user terminal 10 according to the present embodiment includes a storage unit 110, a communication unit 120, a control unit 130, a display unit 140, a sound output unit 150, a sound input unit 160, an operation unit 170, and an imaging unit 180.

### (Storage Unit)

The storage unit 110 is a storage device capable of storing a program and data for operating the control unit 130. Furthermore, the storage unit 110 can also temporarily store various kinds of data required in the process of the operation of the control unit 130. For example, the storage device may be a non-volatile storage device.

### (Communication Unit)

The communication unit 120 includes a communication interface, and communicates with the information processing apparatus 20 via the network 5. For example, the communication unit 120 receives content data, a voice of another user, and sound control information from the information processing apparatus 20.

### (Control Unit)

The control unit 130 includes a central processing unit (CPU) and the like, and a function thereof can be implemented by the CPU developing a program stored in the storage unit 110 in a random access memory (RAM) and executing the program. At this time, a computer-readable recording medium in which the program is recorded can also be provided. Alternatively, the control unit 130 may be configured by dedicated hardware, or may be configured by a combination of a plurality of pieces of hardware. Such a control unit 130 controls the overall operation in the user terminal 10. For example, the control unit 130 controls communication between the communication unit 120 and the information processing apparatus 20. Furthermore, as shown in FIG. 2, the control unit 130 has a function as the output sound generation unit 132.

The control unit 130 performs control to cause the communication unit 120 to transmit, to the information processing apparatus 20 as remote user information, the voice of the user U or the sound made by the user U supplied from the sound input unit 160, the operation status of the user terminal 10 of the user U supplied from the operation unit 170, and the information indicating the state or the action of the user U supplied from the imaging unit 180.

The output sound generation unit 132 performs output processing of applying the sound control information received from the information processing apparatus 20 to the content data and another user voice and causing the sound output unit 150 to output the content data and the another user voice. For example, the output sound generation unit 132 controls the volume, sound quality, or sound image localization of the sound included in the content data and the another user voice according to the sound control information.

### (Display Unit)

The display unit 140 has a function of displaying various kinds of information under the control of the control unit 130. For example, the display unit 140 displays a video included in content data received from the information processing apparatus 20.

### (Sound Output Unit)

The sound output unit 150 is a sound output device such as a speaker or a headphone, and has a function of converting sound data into a sound and outputting the sound under the control of the control unit 130. The sound output unit 150 may be, for example, a headphone having one channel on each of the left and right sides, or may be a speaker system built in a smartphone prepared for one channel on each of the left and right sides. Furthermore, the sound output unit 150 may be a 5.1 CH surround speaker or the like, and includes at least two or more sound generation sources. Such a sound output unit 150 enables the user U to listen to each of the sound included in the content data and the voice of the another user as a sound localized at a predetermined position.

### (Sound Input Unit)

The sound input unit 160 is a sound input device such as a microphone that detects the voice of the user U or the sound made by the user U. The user terminal 10 detects a voice of the user U talking with another user by the sound input unit 160. The sound input unit 160 supplies the detected voice of the user U or sound made by the user U to the control unit 130.

### (Operation Unit)

The operation unit 170 is configured to be operated by the user U or an operator of the user terminal 10 to input an instruction or information to the user terminal 10. For example, the user U may operate the operation unit 170 while viewing the content distributed from the information processing apparatus 20 and output to the user terminal 10, thereby transmitting a reaction to the content in real time using a text, a stamp, or the like using a chat function. Alternatively, the user U may use a so-called coin throwing system that sends a realizable item to the performer in the content by operating the operation unit 170. Such an operation unit 170 supplies an operation status of the user terminal 10 of the user U to the control unit 130.

### (Imaging Unit)

The imaging unit 180 is an imaging device having a function of imaging the user U. The imaging unit 180 is, for example, a camera that is built in a smartphone and can image the user U while the user U is viewing a content on the display unit 140. Alternatively, the imaging unit 180 may be an external camera device configured to be communicable with the user terminal 10 via a wired LAN, a wireless LAN, or the like. The imaging unit 180 supplies the video of the user U to the control unit 130 as information indicating a state or an action state of the user U.

### <2-2. Functional Configuration Example of Information Processing Apparatus 20>

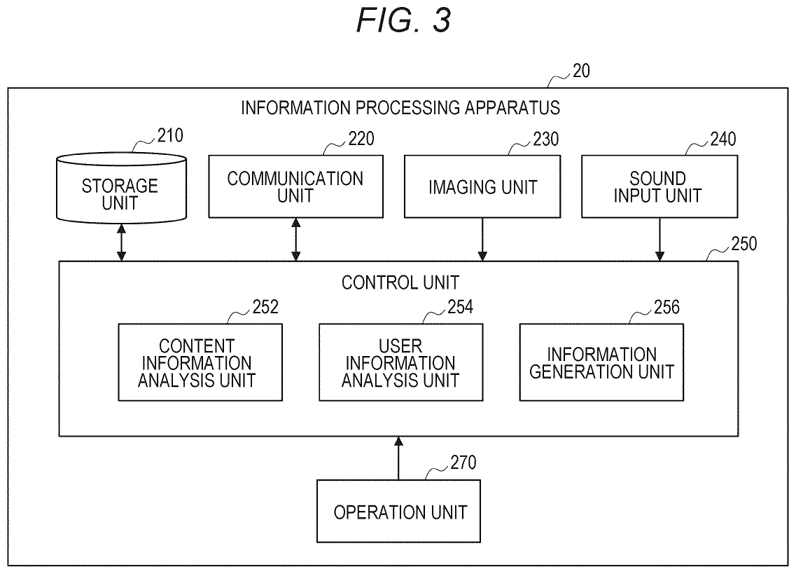

The functional configuration example of the user terminal 10 has been described above. Next, a functional configuration example of the information processing apparatus 20 according to the present embodiment will be described with reference to FIG. 3. As shown in FIG. 3, the information processing apparatus 20 according to the present embodiment includes a storage unit 210, a communication unit 220, an imaging unit 230, a sound input unit 240, a control unit 250, and an operation unit 270.

### (Storage Unit)

The storage unit 210 is a storage device capable of storing a program and data for operating the control unit 250. Furthermore, the storage unit 210 can also temporarily store various kinds of data required in the process of the operation of the control unit 250. For example, the storage device may be a non-volatile storage device. Such a storage unit 210 may store auxiliary information to be used as information for improving the accuracy of analysis when the control unit 250 performs analysis to be described later. The auxiliary information includes, for example, information indicating a progress schedule of the content, information indicating an order of songs scheduled to be played, or information indicating a production schedule.

### (Communication Unit)

The communication unit 220 includes a communication interface and has a function of communicating with the user terminal 10 via the network 5. For example, the communication unit 220 transmits the content data, the voice of another user, and the sound control information to the user terminal 10 under the control of the control unit 250.

### (Imaging Unit)

The imaging unit 230 is an imaging device that images a state where the performer P1 is performing performance. Furthermore, in a case where there is the user X who is an audience viewing the performance at the live venue in the live venue, the imaging unit 230 images the state of the user X and detects the state or the action of the user X. The imaging unit 230 supplies a video image of the detected state or action of the user X to the control unit 250 as venue user information. For example, the imaging unit 230 may detect that the user X shows a reaction such as clapping or jumping by imaging the state of the user X. Alternatively, the imaging unit 230 may detect the movement of the device D1 by imaging the device D1 such as a penlight gripped by the user X. Note that the imaging unit 230 may include a single imaging device or may include a plurality of imaging devices.

### (Sound Input Unit)

The sound input unit 240 is a sound input device that collects a sound of a state where the performer P1 is performing performance. The sound input unit 240 includes, for example, a microphone that detects the voice of the performer P1 or the sound of the music being played. Furthermore, in a case where there is the user X who is an audience viewing the performance at the live venue in the live venue, the sound input unit 240 detects the sound of the cheer of the user X and supplies the sound to the control unit 250 as venue user information together with the video of the state or the action of the user X. Note that the sound input unit 240 may include a single sound input device or may include a plurality of sound input devices.

### (Control Unit)

The control unit 250 includes a central processing unit (CPU) and the like, and a function thereof can be implemented by the CPU developing a program stored in the storage unit 210 in a random access memory (RAM) and executing the program. At this time, a computer-readable recording medium in which the program is recorded can also be provided. Alternatively, the control unit 250 may be configured by dedicated hardware, or may be configured by a combination of a plurality of pieces of hardware. Such a control unit 250 controls the overall operation in the information processing apparatus 20. For example, the control unit 250 controls communication between the communication unit 220 and the user terminal 10.

The control unit 250 has a function of analyzing the video and the sound of the state where the performer P1 is performing performance supplied from the imaging unit 230 and the sound input unit 240. Furthermore, the control unit 250 has a function of analyzing the venue user information supplied from the imaging unit 230 and the sound input unit 240 and the remote user information received from the user terminal 10. The control unit 250 generates and outputs sound control information, which is information for the user terminal 10 to perform output processing of the sound included in the content data and the voice of the another user, on the basis of the result of the analysis.

Furthermore, the control unit 250 has a function of performing control to distribute video and sound data of a state where the performer P1 is performing performance to the user terminal 10 together with the sound control information as content data. Furthermore, in a case where it is detected that the user U is having a conversation with another user, the control unit 250 performs control to distribute the conversation voice of the user U to the another user who is a conversation partner. Such a control unit 250 has functions as a content information analysis unit 252, a user information analysis unit 254, and an information generation unit 256. Note that the information generation unit 256 is an example of an information output unit.

The content information analysis unit 252 has a function of analyzing the video and the sound of the state where the performer P1 is performing performance supplied from the imaging unit 230 and the sound input unit 240, and generating content analysis information. The video and the sound of the state where the performer P1 is performing performance are examples of the first time-series data.

The content information analysis unit 252 analyzes the video and the sound, and detects a progress status of the content. For example, the content information analysis unit 252 detects a situation such as during performance, during a performer's utterance, before the start, after the end, during an intermission, or during a break as the progress status. At this time, the content information analysis unit 252 may use the auxiliary information stored in the storage unit 210 as the information for improving the accuracy of the analysis. For example, the content information analysis unit 252 detects that the progress status of the content is during performance at a latest certain point of time from time-series data of the video and the sound. Furthermore, the content information analysis unit 252 may refer to information indicating a progress schedule of the content as the auxiliary information, recognize the certainty of the detection result, and perform the detection.

Furthermore, in a case where the detected progress status is during performance, the content information analysis unit 252 analyzes the time-series data of the sound and recognizes the music being played. At this time, the content information analysis unit 252 may refer to information indicating the order of songs scheduled to be played in the content as the auxiliary information to improve the accuracy of the recognition.

Furthermore, the content information analysis unit 252 analyzes the time-series data of the sound, and detects a tune of the recognized music. For example, the content information analysis unit 252 detects Active, Normal, Relax, or the like as the tune. The above tune is an example, and the detected tune is not limited to this example. For example, the content information analysis unit 252 may detect another tune as the tune. Alternatively, in order to detect the tune, the content information analysis unit 252 may analyze the genre of the music such as ballard, acoustic, vocal, and Jazz, and use the genre for detecting the tune. Furthermore, the content information analysis unit 252 may improve the accuracy of detection of the tune by using information regarding the production schedule as the auxiliary information.

Furthermore, the content information analysis unit 252 analyzes the time-series data of the video, and infers sound image localization of the sound of the content suitable for the situation in which the content is in progress. For example, the content information analysis unit 252 may perform the above inference by using model information obtained by learning using a video of a state where one or two or more pieces of music are being played and information of sound image localization of a sound corresponding to the video associated with the video.

The content information analysis unit 252 generates content analysis information by using the detected progress status, the recognized music, and the inferred information of sound image localization. Note that details of the content analysis information will be described later.

The user information analysis unit 254 has a function of analyzing the remote user information received from the user terminal 10 and the venue user information supplied from the imaging unit 230 and the sound input unit 240 to generate user analysis information. The user analysis information includes, for example, information indicating the viewing state of the user U and the degree of excitement of the whole users including the user U and the user X. Furthermore, the remote user information and the venue user information are examples of second time-series data.

The user information analysis unit 254 analyzes the voice of the user U or the sound made by the user U included in the remote user information, and detects whether or not the user U is having a conversation with another user. In a case where the user information analysis unit 254 detects that the user U is having a conversation with another user, the information indicating the viewing state of the user U is spk indicating that the user U is having a conversation.

Furthermore, the user information analysis unit 254 analyzes information indicating a state or an action state of the user U included in the remote user information, and detects whether or not the user U is watching the screen of the user terminal 10. For example, the user information analysis unit 254 detects whether or not the user U is watching the screen of the user terminal 10 by detecting the line of sight of the user U. In a case of detecting that the user U is not watching the screen of the user terminal 10, the user information analysis unit 254 sets the viewing state of the user U to nw indicating that the user U is not watching the screen.

Furthermore, the user information analysis unit 254 analyzes the operation status of each of the plurality of user terminals 10 included in the remote user information, and detects the degree of excitement of the whole users U. For example, in a case where each of the plurality of user terminals 10 is performing an operation such as using a chat function or a coin throwing function, the user information analysis unit 254 sets the viewing state of the user U using the user terminal 10 on which the above operation is performed as r indicating that the user U is making a reaction. Furthermore, in a case where the viewing states of the number of users U exceeding the reference are the above-described r, the user information analysis unit 254 may detect that the degree of excitement of the whole users U is high.

Furthermore, the user information analysis unit 254 analyzes the video of the state or the action of each of the users X included in the venue user information, the sound of the cheer of the user X, or the position information of the device D1, and detects the degree of excitement of the whole users X. For example, the user information analysis unit 254 may analyze the volume of the cheer of the user X and detect that the degree of excitement of the whole users X is high in a case where the volume exceeds the reference. Alternatively, the user information analysis unit 254 may detect that the degree of excitement of the whole users X is high in a case where it is detected from the analysis result of the position information of the device D1 that the number of users X exceeding the reference is performing an action of swinging the device D1.

The user information analysis unit 254 combines the degree of excitement of the whole users U and the degree of excitement of the whole users X to detect the degree of excitement of the whole users. The degree of excitement of the whole users may include High as information indicating a state where the degree of excitement is high, Low as information indicating a state where the degree of excitement is low, and Middle as information indicating the degree of excitement between Low and High.

The user information analysis unit 254 generates the user analysis information using the detected viewing state of the user U and the degree of excitement of the whole users. Note that details of the user analysis information will be described later.

The information generation unit 256 generates and outputs sound control information on the basis of the content analysis information and the user analysis information. Note that details of the sound control information will be described later.

### (Operation Unit)

The operation unit 270 is configured to be operated by an operator of the information processing apparatus 20 to input an instruction or information to the information processing apparatus 20. For example, the operator of the information processing apparatus 20 can input the auxiliary information used for analysis by the content information analysis unit 252 by operating the operation unit 270 and store the auxiliary information in the storage unit 210.

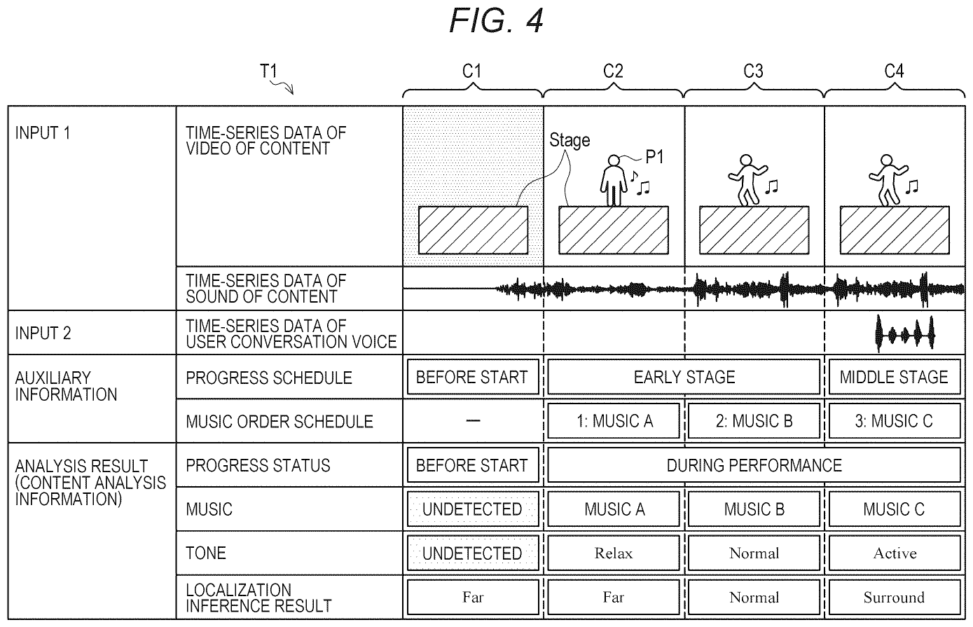

The functional configuration example of the information processing apparatus 20 has been described above. Here, a specific example of the analysis result or the sound control information output by each of the content information analysis unit 252, the user information analysis unit 254, and the information generation unit 256 of the information processing apparatus 20 will be described in more detail with reference to FIGS. 4, 5, and 6.

### (Content Analysis Information)

First, a specific example of the content analysis information generated by the content information analysis unit 252 will be described with reference to FIG. 4. FIG. 4 is an explanatory diagram for explaining the specific example of the content analysis information. In Table T1 shown in FIG. 4, the leftmost column includes input 1, input 2, auxiliary information, and an analysis result (content analysis information).

The input 1 and the input 2 indicate data to be analyzed which is acquired by the content information analysis unit 252. The auxiliary information indicates auxiliary information used for analysis by the content information analysis unit 252. The analysis result (content analysis information) indicates content analysis information generated as a result of the content information analysis unit 252 analyzing the data indicated in the input 1 and the input 2 using the data indicated in the auxiliary information.

In FIG. 4, all the data indicated by the input 1, the input 2, the auxiliary information, and the analysis result (content analysis information) are time-series data, and time advances from the left side to the right side of Table T1. In addition, among the columns of Table T1 shown in FIG. 4, a time section C1 to a time section C4 indicate a certain time section. In FIG. 4, data vertically arranged in the same column in the time section C1 to the time section C4 is indicated as being associated as time-series data of the same time section.

The input 1 includes the time-series data of the video of the content and the time-series data of the sound of the content as shown in the second column from the left of Table T1. The time-series data of the video of the content represents the video of the state where the performer P1 is performing performance supplied from the imaging unit 230 of the information processing apparatus 20 to the content information analysis unit 252. In the example shown in FIG. 4, the diagram shown in the time-series data of the video of the content represents a video at a certain point of time of a state where the performer P1 is performing performance in each of the four time sections of the time section C1, the time section C2, the time section C3, and the time section C4. Furthermore, as shown in the time section C1 and the time section C2, the time-series data of the video of the content is the time-series data of the video including the stage of the live venue and the performer P1.

Furthermore, the time-series data of the sound of the content included in the input 1 represents the sound of the state where the performer P1 is performing performance supplied from the sound input unit 240 of the information processing apparatus 20 to the content information analysis unit 252. In the example shown in FIG. 4, the time-series data of the sound of the content is represented as waveform data of the sound. In FIG. 4, in the waveform data, time advances from the left side to the right side of Table T1.

The input 2 includes time-series data of user conversation voice as shown in the second column from the left of Table T1. The time-series data of the user conversation voice indicates time-series data of the voice of the user U included in the remote user information transmitted from the user terminal 10 to the information processing apparatus 20. In the example shown in FIG. 4, the time-series data of the user conversation voice is represented as waveform data of the sound, similarly to the time-series data of the sound of the content. In the example shown in FIG. 4, waveform data is shown only in the time section C4. Therefore, it is understood that the conversation voice of the user U has been detected only during the time section C4.

In the example shown in FIG. 4, the auxiliary information includes a progress schedule and a song order schedule. The progress schedule includes before the start, the early stage, and the middle stage. Furthermore, the song order schedule includes 1: music A, 2: music B, and 3: music C.

The analysis result (content analysis information) includes a progress status, music, a tune, and a localization inference result. The progress status includes before the start and during performance. The music includes undetected, music A, music B, and music C. The tune includes undetected, Relax, Normal, and Active. In addition, the localization inference result includes Far, Normal, and Surround. Furthermore, the localization inference result may include Near (not shown in FIG. 4). In the present embodiment, Far indicates localization in which the user U feels that the sound included in the content is heard from a distant position for the user U. Near indicates localization in which the user U feels that the sound included in the content is heard from a position close to the user U. Normal indicates localization in which the user U feels that the sound included in the content is heard from a position between Far and Near. Surround indicates localization in which the user U feels that the sound is heard as if surrounding the user U himself/herself.

Next, an analysis result (content analysis information) for each of the time sections C1 to C4 will be described. In the time section C1, the video before the performance is started is shown as the time-series data of the video of the content of the input 1. In addition, waveform data of the sound is shown as the time-series data of the sound of the content.

The waveform data of the sound is not shown in the time-series data of the user conversation voice in the time section C1 of the input 2, and it is understood that the conversation voice of the user U is not detected in the time section C1. In addition, it is understood that the performance is scheduled to be not yet started in the time section C1 in the progress schedule of the auxiliary information. Furthermore, since there is no data in the song order schedule, it is understood that there is no music scheduled to be played in the time section C1.

From the data indicated by the input 1, the input 2, and the auxiliary information described above, the content information analysis unit 252 detects that the progress status of the content is before the start as the analysis result in the time section C1. Furthermore, the content information analysis unit 252 regards the recognition result of the music as undetected and the analysis result of the tune as undetected from the time-series data of the sound of the content. Furthermore, the content information analysis unit 252 infers, from the time-series data of the video of the content, the localization suitable as the sound image localization of the sound of the content in the time section of the time section C1 as Far indicating the localization in which the user U feels that the sound is heard from a distant position.

In the time section C2, the whole-body video in which the performer P1 is performing performance on the stage is shown as the time-series data of the video of the content of the input 1. In addition, waveform data of the sound is shown as the time-series data of the sound of the content.

The waveform data of the sound is not indicated in the time-series data of the user conversation voice in the time section C2 of the input 2, and it is understood that the conversation voice of the user U is not detected in the time section C2. Furthermore, in the progress schedule of the auxiliary information, it is understood that the performance is started in the time section C2, and is in in the progress schedule of the entire music live show, the time section C2 is in a schedule of a time zone of the early stage after the performance is started. Further, it is understood that the music A with the first song order is scheduled to be played in the song order schedule in the time section C2.

From the data indicated by the input 1, the input 2, and the auxiliary information described above, the content information analysis unit 252 detects that the progress status of the content is during performance as the analysis result in the time section C2. In addition, the content information analysis unit 252 recognizes that the music being played is the music A from the time-series data of the sound of the content in the time section C2. In addition, the content information analysis unit 252 detects that the tune of the music A in the time section C2 is Relax indicating a tune having a quiet and calm atmosphere. Furthermore, the content information analysis unit 252 infers, from the time-series data of the video of the content, the localization suitable as the sound image localization of the sound included in the content in the time section C2 as Far indicating the localization in which the user U feels that the sound is heard from a distant position.

In the time section C3, the whole-body video in which the performer P1 is performing performance while dancing on the stage is shown as the time-series data of the content of the input 1. In addition, waveform data of the sound is shown as the time-series data of the sound of the content in the time section C3.

It is understood that the waveform data of the sound is not indicated in the time-series data of the user conversation voice in the time section C3 of the input 2, and the conversation voice of the user U is not detected in the time section C3. In addition, in the progress schedule of the auxiliary information, it is understood that the performance is started in the time section C3 and the time section C3 is in a schedule of a time zone of the early stage. Further, in the song order schedule, it is understood that the music B with the second song order is scheduled to be played.

From the data indicated by the input 1, the input 2, and the auxiliary information described above, the content information analysis unit 252 detects that the progress status of the content is during performance as the analysis result in the time section C3. In addition, the content information analysis unit 252 recognizes that the music being played is the music B from the time-series data of the sound of the content. Further, the content information analysis unit 252 detects that the tune of the music B is Normal. Furthermore, the content information analysis unit 252 infers, from the time-series data of the video of the content, the localization suitable as the sound image localization of the sound of the content in the time section C3 as Normal indicating the localization in which the user U feels that the sound is heard from the position that is not too far and is not too close.

In the time section C4, the whole-body video in which the performer P1 is performing performance while dancing on the stage is shown as the time-series data of the content of the input 1. In addition, waveform data of the sound is shown as the time-series data of the sound of the content.

The time-series data of the user conversation voice in the time section C4 of the input 2 indicates the waveform data of the sound, and it is understood that the conversation voice of the user U is detected during the time section C4. Furthermore, in the progress schedule of the auxiliary information, it is understood that the performance is performed in the time section C4, and the time section C4 is in a schedule of a time zone of the middle stage in the progress schedule of the entire music live show. Further, it is understood that the music C with the third song order is scheduled to be played in the song order schedule in the time section C4.

From the data indicated by the input 1, the input 2, and the auxiliary information described above, the content information analysis unit 252 detects that the progress status of the content is during performance as the analysis result in the time section C4. In addition, the content information analysis unit 252 recognizes that the music being played in the time section C4 is the music C from the time-series data of the sound of the content. Further, the content information analysis unit 252 detects that the tune of the music C in the time section C4 is Active indicating that the tempo is fast and the atmosphere is lively. Furthermore, the content information analysis unit 252 infers, from the time-series data of the video of the content, the localization suitable as the sound image localization of the sound of the content in the time section C4 as Surround indicating the localization in which the user U feels that the sound is heard as if surrounding the user U himself/herself.

The specific example of the content analysis information generated by the content information analysis unit 252 has been described above with reference to FIG. 4. Note that the time section C1 to the time section C4 shown in FIG. 4 are shown as certain time sections while one piece of music is played while the content is in progress, but the time interval at which the content information analysis unit 252 performs analysis is not limited to this example. For example, the content information analysis unit 252 may perform analysis in real time, or may perform analysis at an arbitrary time interval set in advance.

### (User Analysis Information)

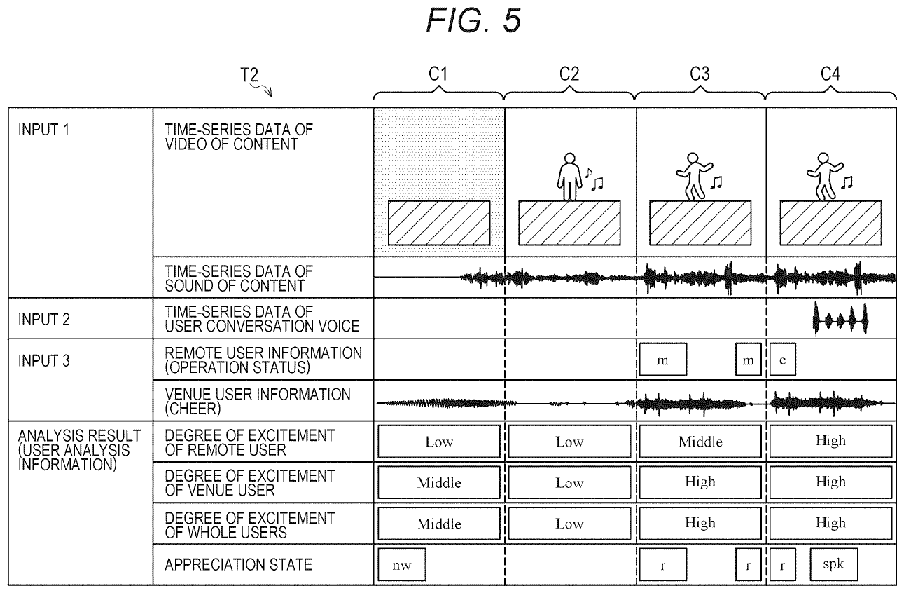

Next, a specific example of the user analysis information generated by the user information analysis unit 254 will be described with reference to FIG. 5. FIG. 5 is an explanatory diagram for explaining a specific example of the user analysis information. In the user analysis information shown in Table T2 of FIG. 5, the content analysis information shown in Table T1 of FIG. 4, the time-series data of the video of the same content, the time-series data of the sound of the content, and the time-series data of the user conversation voice are analyzed.

The leftmost column of Table T2 shown in FIG. 5 includes input 1, input 2, input 3, and an analysis result (user analysis information). The input 1, the input 2, and the input 3 indicate data to be analyzed which is acquired by the user information analysis unit 254. The analysis result (user analysis information) indicates user analysis information generated as a result of analyzing the data indicated in the input 1, the input 2, and the input 3 by the user information analysis unit 254. Note that the data indicated in the input 1 and the input 2 have the same contents as the input 1 and the input 2 included in the table T1 shown in FIG. 4, and are as described above with reference to the table T1 in FIG. 4, and thus, detailed description thereof is omitted here.

Similarly to Table T1 of FIG. 4, in FIG. 5, all of the data indicated in the input 1, the input 2, the input 3, and the analysis result (user analysis information) are time-series data, and time advances from the left side to the right side of Table T2.

The input 3 includes remote user information (operation status) and venue user information (cheer) as shown in the second column from the left of Table T2. The remote user information (operation status) refers to data of information indicating the operation status of each of the user terminals 10 included in the remote user information received by the user information analysis unit 254 from the user terminal 10.

In FIG. 5, the remote user information (operation status) includes c and s. c indicates that the user U has performed an operation of transmitting a certain reaction while viewing the content using the chat function. s indicates that the user U has performed an operation of sending an item having a monetary value to the performer P1 using the coin throwing function.

The venue user information (cheer) indicates data of the sound of the cheer of the user X included in the venue user information received by the user information analysis unit 254 from the user terminal 10. In the example shown in FIG. 5, the venue user information (cheer) is represented as waveform data of sound. In FIG. 5, in the waveform data, time advances from the left side to the right side of Table T2.

The analysis result (user analysis information) includes the degree of excitement of the remote user, the degree of excitement of the venue user, the degree of excitement of the whole users, and the viewing state. The degree of excitement of the remote user, the degree of excitement of the venue user, and the degree of excitement of the whole users include Low, Middle, and High. Furthermore, the viewing state includes nw, r, and spk.

Next, an analysis result (user analysis information) will be described for each section of the time section C1 to the time section C4. In the time section C1, c is displayed as the remote user information (operation status) of the input 3. Therefore, it is understood that the user U has performed an operation using the chat function at the timing when c is displayed.

The waveform data of the sound indicated in the venue user information (cheer) of the time section C1 indicates that the cheer of the user X is detected in the time section C1. In the example shown in FIG. 5, the volume of the cheer of the user X in the time section C1 is larger than the cheer of the user X detected in the time section C2, and is smaller than the cheer of the user X detected in the time section C3 and the time section C4.

From the data indicated in the input 1, the input 2, and the input 3 described above, the user information analysis unit 254 detects that the degree of excitement of the remote user is Low as the analysis result in the time section C1. Furthermore, the user information analysis unit 254 detects that the degree of excitement of the venue user in the time section C1 is Middle on the basis of the data indicated in the venue user information (cheer) of the time section C1. Alternatively, the user information analysis unit 254 may detect that the degree of excitement of the venue user is Middle on the basis of the analysis result of the position information of the device D1 included in the remote user information (not shown in FIG. 5).

The user information analysis unit 254 combines the degree of excitement of the remote user and the degree of excitement of the venue user, and detects that the degree of excitement of the whole users in the time section C1 is Middle. For example, the user information analysis unit 254 may calculate the degree of excitement of the whole users by weighting each of the degree of excitement of the remote user and the degree of excitement of the venue user.

Furthermore, the user information analysis unit 254 detects the state of nw as the viewing state of the user U in the time section C1 from the time-series data of the user conversation voice of the input 2, the remote user information (operation status) of the input 3, and the information indicating the state or the action of the user included in the remote user information (not shown in FIG. 5) in the time section C1. As described above, nw indicates that the user U is not watching the screen of the user terminal 10.

Since no data is shown in the remote user information (operation status) of the input 3 in the time section C2, it is understood that no operation of the user terminal 10 is detected in the time section C2. The waveform data of the sound indicated in the venue user information (cheer) of the time section C2 indicates that the cheer of the user X is detected in the time section C2. Furthermore, in the example shown in FIG. 5, the volume of the cheer of the user X in the time section C2 is smaller than the cheer of the user X detected in any of the time section C1, the time section C3, and the time section C4.

From the data indicated in the input 1, the input 2, and the input 3 described above, the user information analysis unit 254 detects that both the degree of excitement of the remote user and the degree of excitement of the venue user are Low as analysis results in the time section C2. The user information analysis unit 254 combines the degree of excitement of the remote user and the degree of excitement of the venue user, and detects that the degree of excitement of the whole users in the time section C2 is Low.

Furthermore, no data is shown in the viewing state in the time section C2. Therefore, it is understood that the user information analysis unit 254 detects that the viewing state of the user U in the time section C2 is not any of the states nw, r, and spk from the time-series data of the user conversation voice of the input 2, the remote user information (operation status) of the input 3, and the information indicating the state or the action of the user included in the remote user information (not shown in FIG. 5) in the time section C2.

In the time section C3, m indicating that the user U has performed an operation using the coin throwing function is shown in the remote user information (operation status) of the input 3. The waveform data of the sound indicated in the venue user information (cheer) of the time section C3 indicates that the cheer of the user X is detected in the time section C3. In the example shown in FIG. 5, the volume of the cheer of the user X in the time section C3 is larger than the cheer of the user X detected in the time section C1 and the time section C2, and is about the same as the volume of the cheer of the user X detected in the time section C4.

From the data indicated in the input 1, the input 2, and the input 3 described above, the user information analysis unit 254 detects that the degree of excitement of the remote user is Middle as the analysis result in the time section C3. Furthermore, the user information analysis unit 254 detects that the degree of excitement of the venue user is High. The user information analysis unit 254 combines the degree of excitement of the remote user and the degree of excitement of the venue user, and detects that the degree of excitement of the whole users in the time section C3 is High.

Furthermore, the user information analysis unit 254 detects that the viewing state of the user U in the time section C3 is the state of r twice from the time-series data of the user conversation voice of the input 2, the remote user information (operation status) of the input 3, and the information indicating the state or the action of the user U included in the remote user information (not shown in FIG. 5) in the time section C3. In the example shown in FIG. 5, the viewing state is detected on the basis of an operation having been performed by the user U using the coin throwing function as shown in the remote user information (operation status) of the time section C3 of the input 3.

In the time section C4, c is shown in the remote user information (operation status) of the input 3. The waveform data of the sound indicated in the venue user information (cheer) indicates that the cheer of the user X is detected in the time section C4. Furthermore, in the example shown in FIG. 5, the volume of the cheer of the user X in the time section C4 is larger than the cheer of the user X detected in the time section C1 and the time section C2, and is about the same volume as the cheer of the user X detected in the time section C3.

From the data indicated in the input 1, the input 2, and the input 3 described above, the user information analysis unit 254 detects that both the degree of excitement of the remote user and the degree of excitement of the venue user are High as analysis results in the time section C4. The user information analysis unit 254 combines the degree of excitement of the remote user and the degree of excitement of the venue user, and detects that the degree of excitement of the whole users in the time section C4 is High.

Furthermore, the user information analysis unit 254 detects that the viewing state of the user U in the time section C4 is the state of r and spk from the time-series data of the user conversation voice of the input 2, the remote user information (operation status) of the input 3, and the information indicating the state or the action of the user included in the remote user information (not shown in FIG. 5). In the example shown in FIG. 5, in the viewing state, spk is detected on the basis of detection of the voice as the time-series data of the user conversation voice of the input 2.

The specific example of the user analysis information generated by the user information analysis unit 254 has been described above with reference to FIG. 5. Note that the time section C1 to the time section C4 shown in FIG. 5 are shown as certain time sections while one piece of music is played while the content is in progress similarly to FIG. 4, but the time interval at which the user information analysis unit 254 performs analysis is not limited to this example. For example, the user information analysis unit 254 may perform analysis in real time, or may perform analysis at an arbitrary time interval set in advance.

### (Sound Control Information)

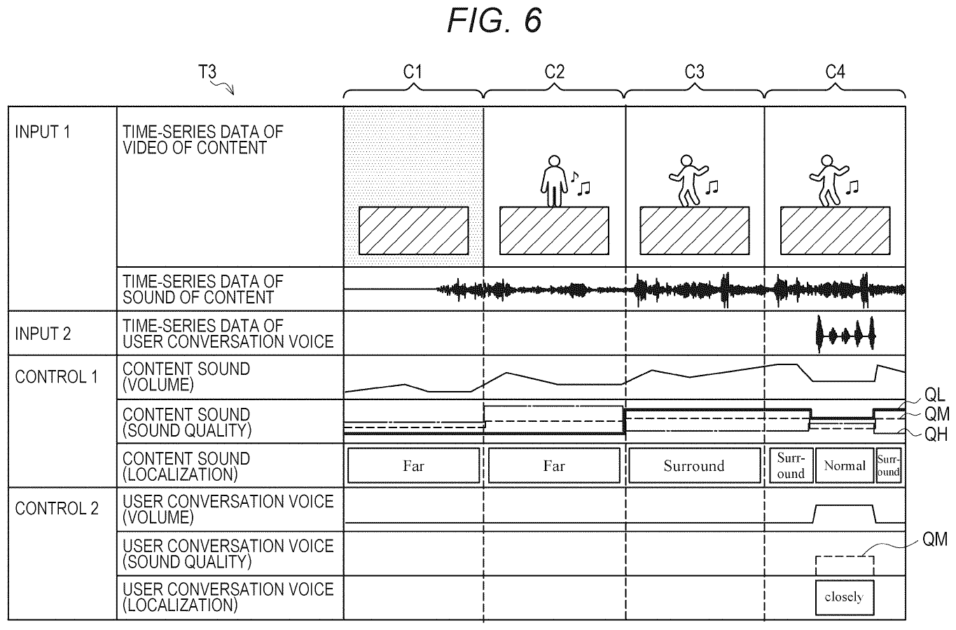

Next, a specific example of the sound control information output by the information generation unit 256 on the basis of the content analysis information and the user analysis information will be described with reference to FIG. 6. FIG. 6 is an explanatory diagram for explaining a specific example of the sound control information. The sound control information shown in Table T3 of FIG. 6 is the sound control information output on the basis of the content analysis information shown in Table T1 of FIG. 4 and the user analysis information shown in Table T2 of FIG. 5 described above.

In Table T3 shown in FIG. 6, data vertically arranged in each column of the time section C1 to the time section C4 is indicated as being associated as time-series data of the same time section.

In Table T3 shown in FIG. 6, the leftmost column includes input 1, input 2, control 1, and control 2. The input 1 and the input 2 have the same contents as those of the input 1 and the input 2 included in Table T1 shown in FIG. 4 and Table T2 shown in FIG. 5, and are as described above with reference to Table T1, and thus, detailed description thereof is omitted here.

The control 1 and the control 2 are data output by the information generation unit 256 on the basis of the content analysis information shown in Table T1 and the user analysis information shown in Table T2. The control 1 indicates sound control information for the time-series data of the sound of the content of the input 1. The control 2 indicates sound control information for the time-series data of the user conversation voice of the input 2. The information generation unit 256 outputs sound control information by combining the data of the control 1 and the data of the control 2.

The control 1 includes a content sound (volume), a content sound (sound quality), and a content sound (localization). The content sound (volume) is data indicating how much volume the user terminal 10 is caused to output the sound included in the content data. In the example shown in FIG. 6, the content sound (volume) is indicated by a polygonal line.

The content sound (sound quality) is data indicating how to cause the user terminal 10 to control the sound quality of the sound included in the content data. In the example shown in FIG. 6, the content sound (sound quality) is indicated by three types of polygonal lines of a solid line QL, a broken line QM, and a one-dot chain line QH. The solid line QL indicates the output level of the sound in the low range. The broken line QM indicates the output level of the sound in the middle range. In addition, a one-dot chain line QH indicates the output level of the sound in the high range.

Note that, in the present embodiment, the high range refers to a sound having a frequency of 1 kHz to 20 kHz. The medium range refers to a sound having a frequency of 200 Hz to 1 kHz. In addition, the low range refers to a sound having a frequency of 20 Hz to 200 Hz. However, the information processing apparatus 20 according to the present disclosure may define the frequencies to be the high range, the middle range, and the low range in a frequency band different from the above frequency bands according to the type of the sound source of the sound to be controlled.

The content sound (localization) is data indicating how to cause the user terminal 10 to control and output the sound image localization of the sound included in the content data. In the example shown in FIG. 6, the content sound (localization) includes Far, Surround, and Normal.

The control 2 includes user conversation voice (volume), user conversation voice (sound quality), and user conversation voice (localization). The user conversation voice (volume) is data indicating how much volume the user terminal 10 is caused to output the sound included in the content data. In the example shown in FIG. 6, the content sound (volume) is indicated by a polygonal line.

The user conversation voice (sound quality) is data indicating how to cause the user terminal 10 to control the sound quality of the voice of the user U having a conversation with another user. In the example shown in FIG. 6, the user conversation voice (sound quality) is indicated by three types of polygonal lines of a solid line QL, a broken line QM, and a one-dot chain line QH, similarly to the content sound (sound quality).

The user conversation voice (localization) is data indicating how to cause the user terminal 10 to control the sound image localization of the voice of the user U. In the example shown in FIG. 6, the user conversation voice (localization) includes closely. closely indicates that the user U localizes the sound at a position where the user U feels a close distance feeling, such as when the user U is having a conversation with a person next to the user U. Furthermore, closely indicates localization of a sound such that a sound can be heard from a position closer to the user U than localization of a sound indicated by Near included in the content sound (localization).

Next, the control 1 and the control 2 will be described for each of the time sections C1 to C4. In the time section C1, it is indicated that the information generation unit 256 controls the content sound (volume) of the control 1 to be lower than the content sound (volume) in any of the time sections C2 to C4.

Furthermore, it is indicated that the content sound (sound quality) in the time section C1 indicates that the information generation unit 256 controls all of the low range QL, the middle range QM, and the high range QH to the same level of output. The content sound (volume) and the content sound (sound quality) in the time section C1 are controlled on the basis that it is detected that, among the content analysis information shown in Table T1, the progress status in the time section C1 is before the start and the music and the tune are undetected.

Moreover, it is indicated that the information generation unit 256 has determined the content sound (localization) in the time section C1 as Far. The content sound (localization) in the time section C1 is determined by the information generation unit 256 on the basis that the localization inference result of the content analysis information in the time section C2 shown in Table T1 is Far. Alternatively, the information generation unit 256 may make the above determination on the basis that, among the user analysis information shown in Table T2, the detection result of the degree of excitement of the whole users in the time section C1 is Low, and nw is included in the detection result of the viewing state.

By controlling the volume, sound quality, and localization as described above with respect to the sound included in the content data, the information generation unit 256 can suppress the output of the sound included in the content data to the volume and sound quality at which the atmosphere of the live venue is conveyed to the user U until the music live show is started. Furthermore, by performing the control as described above, it is possible to make the user U feel as if the user U himself/herself hears the sound included in the content data from a distance. Furthermore, while the user U is not watching the screen of the user terminal 10, or in a case of determining that the degree of excitement of the whole users is not increasing, the information generation unit 256 can cause the user terminal 10 to suppress the volume of the sound included in the content data and output the sound.

With the above configuration, the user U can easily hear a conversation with another user and easily have a conversation until the music live show is started. Furthermore, with the configuration as described above, it is possible to make the user U feel the expansion of space, the quietness, or the realistic feeling as when the user U actually waits for the start of the music live show at the venue of the music live show until the music live show starts.

Further, in the time section C1, the time-series data of the user conversation voice of the input 2 is not detected. Therefore, it is indicated that the information generation unit 256 controls the user conversation voice (volume) in the time section C1 of the control 2 to be lower than the user conversation voice (volume) in the time section C4. Furthermore, since no data is shown in the user conversation voice (sound quality) and the user conversation voice (localization) in the time section C1, it is understood that the information generation unit 256 does not output the control information of the user conversation voice (sound quality) and the user conversation voice (localization) in the time section C1.

In the time section C2, it is indicated that the information generation unit 256 controls the content sound (volume) of the control 1 to be higher than the time section C1 and lower than the content sound (volume) in the time sections of the time section C3 and the time section C4.

Furthermore, the content sound (sound quality) in the time section C2 indicates that the information generation unit 256 controls the output level of the middle range QM to be higher than the low range QL and controls the output of the high range QH to be the highest level. Furthermore, it is indicated that the information generation unit 256 has determined the content sound (localization) as Far.

The content sound (volume), the content sound (sound quality), and the content sound (localization) in the time section C2 are controlled on the basis of detection that, among the content analysis information shown in Table T1, the progress status in the time section C2 is during performance, the music being played is the music A, the tune of the state where the music A is being played is Relax, and the localization inference result is Far.

By controlling the volume, sound quality, and localization as described above for the sound included in the content data, the information generation unit 256 can cause the user terminal 10 to output the sound included in the content data with the volume, sound quality, or localization according to the tune of the music or the excitement of the user while the music live show is started and performance is performed. For example, the information generation unit 256 may control the content sound (volume) to be medium on the basis of detection that the degree of excitement of the whole users of the user analysis information shown in Table T2 is Low. Furthermore, the information generation unit 256 may set the output level of the high range QH of the content sound (sound quality) to be higher than the reference on the basis that the tune of the content analysis information shown in Table T1 is Relax.

Further, in the time section C2, the time-series data of the user conversation voice of the input 2 is not detected. Therefore, the information generation unit 256 determines the control contents for the user conversation voice (volume), the user conversation voice (sound quality), and the user conversation voice (localization) of the control 2 in the time section C2 to be the same contents as the control contents in the time section C1 described above.

In the time section C3, it is indicated that the information generation unit 256 controls the content sound (volume) of the control 1 to be higher than the content sound (volume) in the time section of the time section C2.

In addition, it is indicated that the information generation unit 256 performs control so as to control the output level of the low range QL to be the highest and to suppress the output level of the high range QH to be lower than the low range QL and the middle range QM as the content sound (sound quality) of the time section C3. Furthermore, it is indicated that the information generation unit 256 has determined the content sound (localization) as Surround.

Further, in the time section C3, the time-series data of the user conversation voice of the input 2 is not detected. Therefore, the information generation unit 256 controls the user conversation voice (volume), the user conversation voice (sound quality), and the user conversation voice (localization) of the control 2 similarly to the control in the time section C1 and the time section C2 described above.

The content sound (volume), the content sound (sound quality), and the content sound (localization) are controlled on the basis that, among the user analysis information shown in Table T2, the degree of excitement of the whole users in the time section C3 is High, and some kind of reaction is detected as the viewing state of the user U. In the content analysis information shown in Table T1, the music being played in the time section C3 is the music B. In addition, the tune of the state where the music B is being played in the time section C3 is Normal. In addition, the localization inference result in the time section C3 is detected to be Normal. However, the information generation unit 256 determines that the degree of excitement of the whole users is higher than the reference from the user analysis information, increases the output level of the low range QL of the content sound (sound quality) as shown in Table T3, and determines the content sound (localization) as Surround.

With such a configuration, while it is detected that the degree of excitement of the whole users is high, the information generation unit 256 causes the user terminal 10 to perform control such that the user U feels that the sound included in the content data is heard as if surrounding the user U himself/herself. Therefore, with the configuration as described above, the user U can feel an immersive feeling. Furthermore, by emphasizing the low-range sound of the sound included in the content data, it is possible to make the user U feel powerful and excited as when listening to performance at the venue of the music live show.

In the time section C4, it is indicated that the information generation unit 256 controls the content sound (volume) of the control 1 to be higher than the content sound (volume) in the time section of the time section C3 and to be lower while the time-series data of the user conversation voice of the input 2 is detected.

Furthermore, it is indicated that the information generation unit 256 performs control to lower the output levels of the low range QL and the middle range QM and to increase the output level of the high range QH while the time-series data of the user conversation voice is detected as the content sound (sound quality) in the time section C4. Furthermore, it is indicated that the information generation unit 256 determines the content sound (localization) as Surround while the time-series data of the user conversation voice is not detected. Moreover, it is indicated that the information generation unit 256 determines the content sound (localization) as Normal while the time-series data of the user conversation voice is detected.

The user conversation voice (volume) in the time section C4 of the control 2 indicates that the information generation unit 256 performs control to increase the volume of the user conversation voice while the time-series data of the user conversation voice is detected. Furthermore, the user conversation voice (sound quality) indicates that the control to increase the output level of the middle range QM of the user conversation voice is performed while the time-series data of the user conversation voice is detected. Furthermore, the user conversation voice (localization) indicates closely indicating that the user U localizes the sound to a close distance feeling as when the user U is having a conversation with a person next to the user U.

The content sound (volume), the content sound (sound quality), and the content sound (localization) in the time section C4 are controlled on the basis that the degree of excitement of the whole users in the time section C4 is High in the user analysis information shown in Table T2, and on the basis that it is detected that, among the content analysis information shown in Table T1, the music C is played, the tune is Active, and the localization inference result is Surround in the time section C4.

Furthermore, the user conversation voice (volume), the user conversation voice (sound quality), and the user conversation voice (localization) in the time section C4 are controlled on the basis of detection that the viewing state in the time section C4 is spk among the user analysis information shown in Table T2.

In a case of determining that the music being played in the content has an uptempo tune and the degree of excitement of the whole users is higher than the reference, the information generation unit 256 increases the output level of the low range of the sound included in the content and determines the content sound (localization) as Surround. On the other hand, while the time-series data of the user conversation voice of the input 2 is detected, the information generation unit 256 changes the determined content sound (localization) to Normal.

With the above configuration, the user U who is viewing the content can feel a more immersive feeling. Furthermore, while the user U is talking with another user, it is possible to make the user U feel as if the voice of another user who is a conversation partner of the user U is localized at a position with a volume larger than the volume of the sound included in the content data and closer than the localization of the sound included in the content data.

The specific example of the sound control information output by the information generation unit 256 has been described above with reference to FIG. 6. Note that the method of controlling the sound included in the content data and the sound of the voice of another user performed by the information generation unit 256 shown in FIG. 6 is an example, and the control method is not limited to the example described above. In addition, the time section C1 to the time section C4 shown in FIG. 6 are shown as certain time sections while one piece of music is played while the content is in progress, similarly to FIGS. 4 and 5, but the time interval at which the information generation unit 256 outputs the sound control information is not limited to this example. For example, the information generation unit 256 may output the sound control information in real time, or may output the sound control information at an arbitrary time interval set in advance.

### 3. OPERATION PROCESSING EXAMPLE ACCORDING TO PRESENT EMBODIMENT

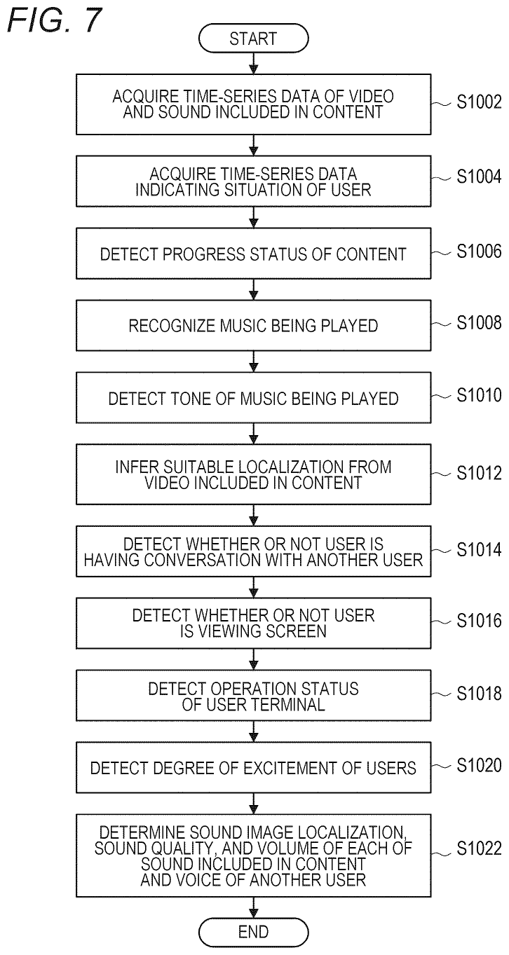

Next, an operation example of the information processing apparatus 20 according to the present embodiment will be described. FIG. 7 is a flowchart showing an operation example of the information processing apparatus 20 according to the present embodiment.

First, the control unit 250 of the information processing apparatus 20 acquires, from the imaging unit 230 and the sound input unit 240, the time-series data of the video and the sound of the state where the performer P1 is performing performance (S1002).

Next, the control unit 250 of the information processing apparatus 20 acquires the remote user information from the user terminal 10 via the communication unit 220. Furthermore, the information processing apparatus 20 acquires venue user information from the imaging unit 230 and the sound input unit 240 (S1004).

Next, the content information analysis unit 252 of the information processing apparatus 20 analyzes the time-series data of the video and the sound of the state where the performance is performed by the performer P1, and detects the progress status of the content (S1006).

Furthermore, the content information analysis unit 252 recognizes music being played in the content (S1008). Further, the content information analysis unit 252 detects a tune of the recognized music (S1010). The content information analysis unit 252 generates content analysis information on the basis of the results of the analysis performed in S1006 to S1010, and provides the content analysis information to the information generation unit 256.

Furthermore, the content information analysis unit 252 infers localization suitable for the situation in which the content is in progress from the video of the state where performance is performed by the performer P1 (S1012).

Next, the user information analysis unit 254 analyzes the remote user information and the venue user information acquired in S1004, and detects whether or not the user U is having a conversation with another user (S1014).

Furthermore, the user information analysis unit 254 analyzes the remote user information and the venue user information, and detects whether or not the user U is watching the screen of the user terminal 10 (S1016).

Furthermore, the user information analysis unit 254 analyzes the remote user information and the venue user information, and detects the degree of excitement of the whole users U and the degree of excitement of the whole users X. The user information analysis unit 254 detects the degree of excitement of the whole users on the basis of the detection result (S1020). The user information analysis unit 254 generates user analysis information on the basis of the results of the analysis performed in S1014 to S1020, and provides the user analysis information to the information generation unit 256.

The information generation unit 256 determines sound image localization, sound quality, and volume for each of the sound included in the content and the voice of another user included in the remote user information on the basis of the content analysis information and the user analysis information (S1022). The information generation unit 256 generates and outputs the sound control information on the basis of the determination content.

The control unit 250 transmits the video and the sound of the state where the performance is performed by the performer P1 acquired in S1002 to the user terminal 10 together with the sound control information as content data. The user terminal 10 applies the sound control information to the received content data and causes the display unit 140 and the sound output unit 150 to output the content data.

### 4. MODIFICATIONS

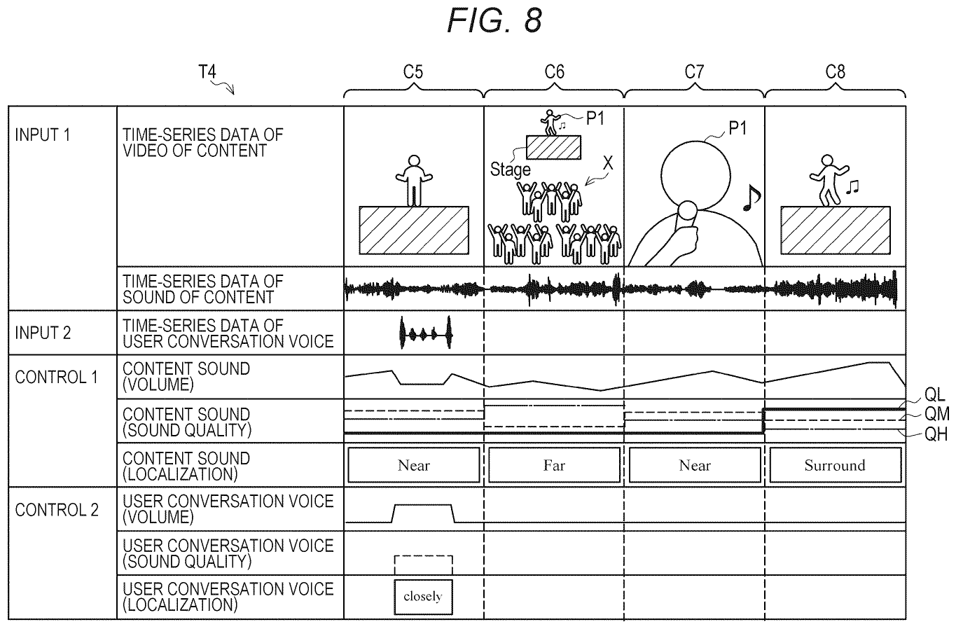

The operation example of the information processing apparatus 20 according to the present embodiment has been described above. Note that, in the present embodiment described above, the specific example has been described with reference to FIG. 6 as the method of controlling the sound included in the content data performed by the information generation unit 256 of the information processing apparatus 20, but the method of controlling the sound by the information processing apparatus 20 is not limited to the example described above. Here, modifications of the sound control information that can be output by the information generation unit 256 of the information processing apparatus 20 will be described with reference to FIG. 8.

FIG. 8 is an explanatory diagram for explaining a specific example of the sound control information output by the information generation unit 256 of the information processing apparatus 20. The leftmost column of Table T4 in FIG. 8 includes input 1, input 2, control 1, and control 2. The items included in the leftmost column and the second column from the left in Table T4 shown in FIG. 8 have the same contents as the items in the leftmost column and the second column from the left shown in Table T3 in FIG. 7, and thus, detailed description thereof is omitted here.

In the column of Table T4 shown in FIG. 8, each of the time section C5 to the time section C8 indicates a certain time section. In Table T4 shown in FIG. 8, data vertically arranged in each column of the time section C5 to the time section C8 is indicated as being associated as time-series data of the same time section.

In the time section C5, as Modification 1, sound control information that can be generated and output by the information processing apparatus 20 in a case where it is detected that the performer P1 is performing MC where the performer P1 performs a chat with an audience at a music live show will be described.

The time-series data of the video of the content of the input 1 in the time section C5 shows a video of a state where the performer P1 is performing MC. Furthermore, the time-series data of the user conversation voice in the time section C5 indicates the waveform data of the sound, and it is understood that it is detected that the user U is having a conversation with another user during the time section C5.

In the time section C5, it is indicated that the information generation unit 256 controls the content sound (volume) of the control 1 to be higher than the content sound (volume) in the time section C6, but controls to suppress the content sound (volume) in the time section C5 while the time-series data of the user conversation voice is detected.

Furthermore, the content sound (sound quality) in the time section C5 indicates that the information generation unit 256 controls the middle range QM to be the highest and the low range QL to be the lowest. Moreover, it is indicated that the information generation unit 256 has determined the content sound (localization) in the time section C5 as Near indicating that the content sound (localization) is controlled to be localization in which the user U feels that the sound included in the content can be heard from a close distance.

With the above configuration, the user U can easily hear the utterance voice of the performer P1 while the performer P1 is performing MC.

Furthermore, the user conversation voice (volume) in the time section C5 indicates that the information generation unit 256 performs control to increase the volume of the conversation voice of the user U only while the time-series data of the user conversation voice is detected.

Furthermore, the user conversation voice (sound quality) indicates that the information generation unit 256 performs control to raise the output of the middle range QM of the conversation voice of the user U only while the time-series data of the user conversation voice is detected. Moreover, it is indicated that the information generation unit 256 has determined the user conversation voice (localization) as closely.

With the above configuration, even while the performer P1 is performing MC, while it is detected that the user U is having a conversation with another user, the user U can easily hear the voice of the another user. Furthermore, the user U can feel as if the user U himself/herself hears the voice of the another user from a distance closer to the user U than the utterance voice of the performer P1.

Next, in the time section C6, as Modification 2, sound control information that can be output by the information generation unit 256 when a video included in the content is a video looking down on a venue where a music live show is performed will be described.

The time-series data of the video of the content of the input 1 in the time section C6 shown a video that includes at least one part of the performer P1 and the user X and looks down on the state of the music live show.

In the time section C6, it is indicated that the information generation unit 256 controls the content sound (volume) of the control 1 to be lower than any of the content sounds (volume) in the time sections C5, C7, and C8.

Furthermore, the content sound (sound quality) in the time section C6 indicates that the information generation unit 256 controls the high range QH to be the highest and the low range QL to be the lowest. Moreover, it is indicated that the information generation unit 256 has determined the content sound (localization) in the time section C6 as Far.

Alternatively, in the time section C6, the information generation unit 256 may determine to control the sound such that reverberation of the sound included in the content can be felt (not shown in FIG. 8).

With the above configuration, in a case where the video included in the content is a video which looks down on the live venue and in which the performer P1 is projected far away, the user U can hear the sound included in the content from a distant position for the user U. Alternatively, it is possible to make the user U feel the expansion of space as in the live venue.

Subsequently, in the time section C7, as Modification 3, an example in a case where the video included in the content is a video in which the performer P1 directs his/her eyes straight toward the imaging unit 230, and a viewer of the video feels as if catching the eyes of the performer P1 will be described.

In the time-series data of the video of the content of the input 1 in the time section C7, a proximity video in which the performer P1 is captured from the front is shown.

In the time section C7, it is indicated that the information generation unit 256 controls the content sound (volume) of the control 1 to be lower than the content sound (volume) of the time section C6.

Furthermore, the content sound (sound quality) in the time section C7 indicates that the information generation unit 256 controls the middle range QM to be the highest and the low range QL to be the lowest. Moreover, it is indicated that the information generation unit 256 has determined the content sound (localization) in the time section C7 as Near.

With the above configuration, in a case where the video included in the content is a proximity video of the performer P1, the user U can perform control such that the sound included in the content can be heard from a position close to the user U. Furthermore, by combining the control of the sound as described above and the video in which the performer P1 directs his/her eyes straight toward the imaging unit 230, the user U can enjoy the feeling as if the eyes of the user U meet the performer P1, and the immersive feeling of the user U can be enhanced.

Subsequently, in the time section C8, as Modification 4, sound control information that can be output by the information generation unit 256 when the progress status of the content approaches the final stage will be described.

The time-series data of the video of the content of the input 1 in the time section C8 shows a whole-body video of a state where the performer P1 performs performance while dancing.

In the time section C8, it is indicated that the information generation unit 256 controls the content sound (volume) of the control 1 to be higher than the content sound (volume) in any of the time section C5 to the time section C7.

Furthermore, the content sound (sound quality) in the time section C8 indicates that the information generation unit 256 controls the low range QL to be the highest and the high range QH to be the lowest. Moreover, it is indicated that the information generation unit 256 has determined the content sound (localization) in the time section C8 as Surround.

With the configuration as described above, in a case where the progress status of the content is the final stage, it is possible to amplify the volume of the sound included in the content and produce a large excitement. Furthermore, while the output level of the low range of the sound included in the content is controlled to be the highest, control is performed such that localization of the sound included in the content becomes localization that allows the user U to hear the sound such that the user U himself/herself is surrounded, and thus, it is possible to make the user U feel powerful and realistic feeling.

### 5. HARDWARE CONFIGURATION EXAMPLE

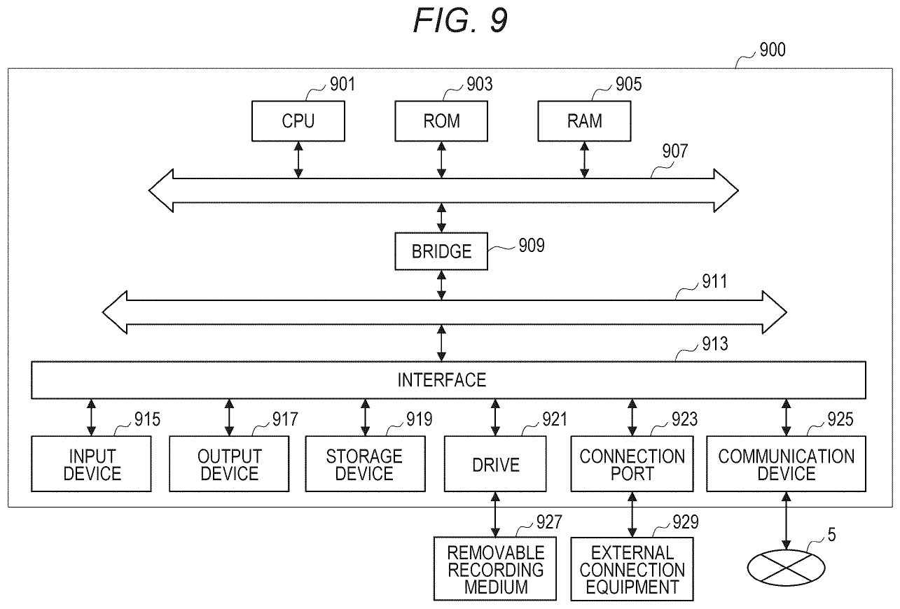

The modifications of the sound control information that can be output by the information generation unit 256 of the information processing apparatus 20 has been described above with reference to FIG. 8. Next, a hardware configuration example of the information processing apparatus 20 according to the embodiment of the present disclosure will be described with reference to FIG. 9.

The processing by the user terminal 10 and the information processing apparatus 20 described above can be implemented by one or a plurality of information processing apparatuses. FIG. 9 is a block diagram showing a hardware configuration example of the user terminal 10 and the information processing apparatus 900 that implements the information processing apparatus 20 according to the embodiment of the present disclosure. Note that the information processing apparatus 900 does not necessarily have the entire hardware configuration shown in FIG. 9. Furthermore, a part of the hardware configuration shown in FIG. 9 may not exist in the user terminal 10 or the information processing apparatus 20.

As shown in FIG. 9, the information processing apparatus 900 includes a CPU 901, a read only memory (ROM) 903, and a RAM 905. Furthermore, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may include a processing circuit called a graphics processing unit (GPU), a digital signal processor (DSP), or an application specific integrated circuit (ASIC) instead of or in addition to the CPU 901.

The CPU 901 functions as an arithmetic processing device and a control device, and controls the overall operation in the information processing apparatus 900 or a part thereof, in accordance with various programs recorded in the ROM 903, the RAM 905, the storage device 919, or a removable recording medium 927. The ROM 903 stores programs, calculation parameters, and the like used by the CPU 901. The RAM 905 temporarily stores a program used in execution by the CPU 901, parameters that change as appropriate during the execution, and the like. The CPU 901, the ROM 903, and the RAM 905 are mutually connected by the host bus 907 including an internal bus such as a CPU bus. Moreover, the host bus 907 is connected to the external bus 911 such as a peripheral component interconnect/interface (PCI) bus via the bridge 909.

The input device 915 is, for example, a device operated by the user, such as a button. The input device 915 may include a mouse, a keyboard, a touch panel, a switch, a lever, or the like. Furthermore, the input device 915 may also include a microphone that detects voice of the user. The input device 915 may be, for example, a remote control device using infrared rays or other radio waves, or may be external connection equipment 929 such as a mobile phone adapted to the operation of the information processing apparatus 900. The input device 915 includes an input control circuit that generates and outputs an input signal to the CPU 901 on the basis of the information input by the user. By operating the input device 915, the user inputs various kinds of data or gives an instruction to perform a processing operation, to the information processing apparatus 900.

Furthermore, the input device 915 may include an imaging device and a sensor. The imaging device is, for example, a device that generates a captured image by capturing a real space using various members such as an imaging element such as a charge coupled device (CCD) or a complementary metal oxide semiconductor (CMOS), and a lens for controlling image formation of a subject image on the imaging element. The imaging device may capture a still image or may capture a moving image.

The sensor is, for example, a sensor of various kinds, such as a distance measuring sensor, an acceleration sensor, a gyro sensor, a geomagnetic sensor, a vibration sensor, a light sensor, or a sound sensor. The sensor obtains information regarding a state of the information processing apparatus 900 itself such as attitude of a casing of the information processing apparatus 900, and information regarding a surrounding environment of the information processing apparatus 900 such as brightness and noise around the information processing apparatus 900, for example. Furthermore, the sensor may also include a global positioning system (GPS) sensor that receives a GPS signal to measure the latitude, longitude, and altitude of the device.

The output device 917 includes a device that can visually or audibly notify the user of acquired information. The output device 917 may be, for example, a display device such as a liquid crystal display (LCD) or an organic electro-luminescence (EL) display, a sound output device such as a speaker or a headphone, or the like. Furthermore, the output device 917 may include a plasma display panel (PDP), a projector, a hologram, a printer device, or the like. The output device 917 outputs a result obtained by the processing of the information processing apparatus 900 as a video such a text or an image, or outputs the result as a sound such as voice or audio. Furthermore, the output device 917 may include a lighting device or the like that brightens the surroundings.

The storage device 919 is a data storage device configured as an example of a storage unit of the information processing apparatus 900. The storage device 919 includes, for example, a magnetic storage device such as a hard disk drive (HDD), a semiconductor storage device, an optical storage device, a magneto-optical storage device, or the like. The storage device 919 stores programs executed by the CPU 901 and various kinds of data, various kinds of data acquired from the outside, and the like.

The drive 921 is a reader/writer for the removable recording medium 927, such as a magnetic disk, an optical disc, a magneto-optical disk, or a semiconductor memory, and is built in or externally attached to the information processing apparatus 900. The drive 921 reads information recorded in the mounted removable recording medium 927, and outputs the read information to the RAM 905. Furthermore, the drive 921 writes records in the mounted removable recording medium 927.

The connection port 923 is a port for directly connecting equipment to the information processing apparatus 900. The connection port 923 may be, for example, a universal serial bus (USB) port, an IEEE1394 port, a small computer system interface (SCSI) port, or the like. Furthermore, the connection port 923 may be an RS-232C port, an optical audio terminal, a high-definition multimedia interface (HDMI (registered trademark)) port, or the like. By connecting the external connection equipment 929 to the connection port 923, various kinds of data can be exchanged between the information processing apparatus 900 and the external connection equipment 929.

The communication device 925 is, for example, a communication interface including a communication device or the like for connecting to the network 5. The communication device 925 may be, for example, a communication card for wired or wireless local area network (LAN), Bluetooth (registered trademark), Wi-Fi (registered trademark), or wireless USB (WUSB). Furthermore, the communication device 925 may be a router for optical communication, a router for asymmetric digital subscriber line (ADSL), a modem for various kinds of communication, or the like. For example, the communication device 925 transmits and receives signals and the like to and from the Internet and other communication equipment, by using a predetermined protocol such as TCP/IP. Furthermore, the network 5 connected to the communication device 925 is a network connected in a wired or wireless manner, and is, for example, the Internet, a home LAN, infrared communication, radio wave communication, satellite communication, or the like.

### 6. CONCLUSION

The preferred embodiments of the present disclosure have been described in detail above with reference to the accompanying drawings, but the present disclosure is not limited to such examples. It is apparent that a person having ordinary knowledge in the technical field to which the present disclosure belongs can devise various change examples or modification examples within the scope of the technical idea described in the claims, and it will be naturally understood that such examples also belong to the technical scope of the present disclosure.

For example, in the above-described embodiment, the user terminal 10 applies the sound control information to the sound included in the content data and the voice of another user on the basis of the sound control information received from the information processing apparatus 20, and performs the output processing, but the present disclosure is not limited to such an example. For example, the information generation unit 256 of the information processing apparatus 20 may apply the sound control information to the sound included in the content data and the another user voice, generate and output distribution data, and transmit the distribution data to the user terminal 10. With such a configuration, the user terminal 10 can output the content without performing the processing of applying the sound control information to the sound included in the content data and the voice of the another user.

Furthermore, in the above-described embodiment, the live distribution of the music live show in which the video and the sound of the performer imaged at the live venue are provided to the user at the remote location in real time has been described as an example, but the present disclosure is not limited to such an example. For example, the content distributed by the information processing apparatus 20 may be a video and a sound of a music live show recorded in advance, or may be other videos and sounds. Alternatively, the user terminal 10 may cause the information processing apparatus 20 to read a video and a sound held in an arbitrary storage medium, analyze and control the video and the sound, and allow the user U to view the video and the sound on the user terminal 10. With such a configuration, it is possible to improve the viewing experience of the user not only for the content distributed in real time via the network but also for the content stored locally by the user terminal or the content recorded in advance.

Furthermore, in the above-described embodiment, the case where the user X who is viewing the performance of the performer P1 is present at the live venue has been described as an example, but the present disclosure is not limited to such an example. For example, there may be no audience in the live venue, and in that case, the user information analysis unit 254 of the information processing apparatus 20 may generate the user analysis information with only the remote user information as the analysis target. Alternatively, even in a case where there is an audience in the live venue, only information indicating the situation of the user U who is viewing the performance of the performer P1 remotely may be the analysis target of the user information analysis unit 254. With such a configuration, it is possible to improve the viewing experience of the user even in a content that can be viewed only by distributing a video and a sound without performing performance directly in front of the audience.

Furthermore, the steps in the processing of the operations of the user terminal 10 and the information processing apparatus 20 according to the present embodiment do not necessarily need to be processed in time series in the order described as the explanatory diagrams. For example, each step in the processing of the operation of the user terminal 10 and the information processing apparatus 20 may be processed in an order different from the order described as the explanatory diagrams, or may be processed in parallel.

Furthermore, it is also possible to create one or more computer programs for causing hardware such as the CPU, the ROM, and the RAM built in the information processing apparatus 900 described above to exhibit the functions of the information processing system 1. Furthermore, a computer-readable storage medium that stores the one or more computer programs is also provided.

Furthermore, the effects described in the present specification are merely exemplary or illustrative, and are not restrictive. That is, the technology according to the present disclosure may exert other effects apparent to those skilled in the art from the description of the present specification in addition to or instead of the effects described above.

Note that the present technology may also have the following configurations.

(1)

An information processing apparatus including an information output unit configured to output sound control information on a basis of an analysis result of first time-series data included in content data and an analysis result of second time-series data indicating a situation of a user,
in which the sound control information includes information for controlling sound image localization of a voice of another user output to a user terminal used by the user or a sound included in the content data.
   (2)

The information processing apparatus according to (1), further including
a communication unit configured to transmit the content data or a voice of the another user and a sound control information to the user terminal.
   (3)

The information processing apparatus according to (1),
in which the information generation unit includes a communication unit configured to
output distribution data obtained by applying the sound control information to a sound included in the content data or the voice of the another user, and
transmit the distribution data to the user terminal.
   (4)

The information processing apparatus according to (2) or (3),
in which the sound control information includes information for controlling a volume of a voice of the another user output to the user terminal or a sound included in the content data.
   (5)

The information processing apparatus according to any one of (2) to (4),
in which the sound control information includes information for controlling sound quality of a voice of the another user output to the user terminal or a sound included in the content data.
   (6)

The information processing apparatus according to any one of (2) to (5), further including
a content information analysis unit configured to analyze the first time-series data,
in which the content information analysis unit detects a progress status of a content.
   (7)

The information processing apparatus according to (6),
in which the content information analysis unit detects, as the progress status, any of during performance, during a performer's utterance, before start, after end, during an intermission, and during a break.
   (8)

The information processing apparatus according to (6) or (7),
in which the content information analysis unit recognizes music being played in the content in a case where it is detected that the progress status is during performance.
   (9)

The information processing apparatus according to any one of (6) to (8),
in which the content information analysis unit analyzes the first time-series data using auxiliary information for improving accuracy of analysis, and
the auxiliary information includes information indicating a progress schedule of the content, information indicating a song order, or information regarding a production schedule.
   (10)

The information processing apparatus according to any one of (6) to (9),
in which the content information analysis unit detects a tune of music being played in the content.
   (11)

The information processing apparatus according to any one of (6) to (10),
in which the first time-series data includes time-series data of a video of the content, and
the information processing apparatus determines information of sound image localization corresponding to the time-series data of the video of the content at a certain point of time on a basis of model information obtained by learning using a video of a state where one or two or more pieces of music are being played and information of sound image localization of a sound corresponding to the video associated with the video.
   (12)

The information processing apparatus according to any one of (2) to (11), further including
a user information analysis unit configured to analyze the second time-series data,
in which the user information analysis unit detects a viewing state of the user,
the viewing state includes information indicating whether or not the user is having a conversation with the another user, information indicating whether or not the user is making a reaction, or information indicating whether or not the user is watching a screen, and
the information generation unit outputs the sound control information on the basis of the detected viewing state.
   (13)

The information processing apparatus according to (12),
in which, in a case where it is detected that the user is in conversation with the another user, the information output unit generates information for controlling sound image localization of a voice of the another user and a sound included in the content data such that the user feels that the voice of the another user is heard from a closer place than the sound included in the content data until it is detected that the user has stopped conversation with the another user.
   (14)

The information processing apparatus according to (12) or (13),
in which, in a case where it is detected that the user is not watching the screen of the user terminal, the information output unit generates information for controlling sound image localization of a sound included in the content data such that the user feels the sound included in the content data is heard from a farther place than a way of hearing immediately before a time point at which it is detected that the user is not watching the screen until it is detected that the user is watching the screen.
   (15)

The information processing apparatus according to any one of (12) to (14),
in which the second time-series data includes a voice of the user, a video of the user, or information indicating an operation status of the user terminal of the user, and
the user information analysis unit detects a degree of excitement of the user on the basis of any one or more of the voice of the user, the video of the user, or information indicating the operation status.
   (16)

The information processing apparatus according to (15),
in which, in a case where it is detected that the degree of excitement of the user is higher than a reference, the information generation unit generates information for controlling sound image localization of a sound included in the content data such that the sound included in the content data sounds to the user as if the sound surrounds the user himself/herself.
   (17)

An information processing method executed by a computer, the computer including
outputting sound control information on a basis of an analysis result of first time-series data included in content data and an analysis result of second time-series data indicating a situation of a user,
in which the sound control information includes information for controlling sound image localization of a voice of another user output to a user terminal used by the user or a sound included in the content data.
   (18)

A program configured to cause a computer to function as an information processing apparatus including an information output unit configured to output sound control information on a basis of an analysis result of first time-series data included in content data and an analysis result of second time-series data indicating a situation of a user,
in which the sound control information includes information for controlling sound image localization of a voice of another user output to a user terminal used by the user or a sound included in the content data.

### REFERENCE SIGNS LIST

1 Information processing system
10 User terminal
120 Communication unit
130 Control unit
132 Output sound generation unit
140 Display unit
150 Sound output unit
160 Sound input unit
170 Operation unit
180 Imaging unit
20 Information processing apparatus
220 Communication unit
230 Imaging unit
240 Sound input unit
250 Control unit
252 Content information analysis unit
254 User information analysis unit
256 Information generation unit
900 Information processing apparatus

1. An information processing apparatus comprising
an information output unit configured to output sound control information on a basis of an analysis result of first time-series data included in content data and an analysis result of second time-series data indicating a situation of a user,
wherein the sound control information includes information for controlling sound image localization of a voice of another user output to a user terminal used by the user or a sound included in the content data.

2. The information processing apparatus according to claim 1, further comprising
a communication unit configured to transmit the content data or a voice of the another user and the sound control information to the user terminal.

3. The information processing apparatus according to claim 1,
wherein the information output unit includes a communication unit configured to output distribution data obtained by applying the sound control information to a sound included in the content data or a voice of the another user, and transmit the distribution data to the user terminal.

4. The information processing apparatus according to claim 2,
wherein the sound control information includes information for controlling a volume of a voice of the another user output to the user terminal or a sound included in the content data.

5. The information processing apparatus according to claim 2,
wherein the sound control information includes information for controlling sound quality of a voice of the another user output to the user terminal or a sound included in the content data.

6. The information processing apparatus according to claim 2, further comprising
a content information analysis unit configured to analyze the first time-series data,
wherein the content information analysis unit detects a progress status of a content.

7. The information processing apparatus according to claim 6,
wherein the content information analysis unit detects, as the progress status, any of during performance, during a performer's utterance, before start, after end, during an intermission, and during a break.

8. The information processing apparatus according to claim 6,
wherein the content information analysis unit recognizes music being played in the content in a case where it is detected that the progress status is during performance.

9. The information processing apparatus according to claim 6,
wherein the content information analysis unit analyzes the first time-series data using auxiliary information for improving accuracy of analysis, and
the auxiliary information includes information indicating a progress schedule of the content, information indicating a song order, or information regarding a production schedule.

10. The information processing apparatus according to claim 6,
wherein the content information analysis unit detects a tune of music being played in the content.

11. The information processing apparatus according to claim 6,
wherein the first time-series data includes time-series data of a video of the content, and
the information processing apparatus determines information of sound image localization corresponding to the time-series data of the video of the content at a certain point of time on a basis of model information obtained by learning using a video of a state where one or two or more pieces of music are being played and information of sound image localization of a sound corresponding to the video associated with the video.

12. The information processing apparatus according to claim 2, further comprising
a user information analysis unit configured to analyze the second time-series data,
wherein the user information analysis unit detects a viewing state of the user,
the viewing state includes information indicating whether or not the user is having a conversation with the another user, information indicating whether or not the user is making a reaction, or information indicating whether or not the user is watching a screen, and
the information output unit outputs the sound control information on the basis of the detected viewing state.

13. The information processing apparatus according to claim 12,
wherein, in a case where it is detected that the user is in conversation with the another user, the information output unit generates information for controlling sound image localization of a voice of the another user and a sound included in the content data such that the user feels that the voice of the another user is heard from a closer place than the sound included in the content data until it is detected that the user has stopped conversation with the another user.

14. The information processing apparatus according to claim 12,
wherein, in a case where it is detected that the user is not watching the screen of the user terminal, the information output unit generates information for controlling sound image localization of a sound included in the content data such that the user feels the sound included in the content data is heard from a farther place than a way of hearing immediately before a time point at which it is detected that the user is not watching the screen until it is detected that the user is watching the screen.

15. The information processing apparatus according to claim 12,
wherein the second time-series data includes a voice of the user, a video of the user, or information indicating an operation status of the user terminal of the user, and
the user information analysis unit detects a degree of excitement of the user on the basis of any one or more of the voice of the user, the video of the user, or information indicating the operation status.

16. The information processing apparatus according to claim 15,
wherein, in a case where it is detected that the degree of excitement of the user is higher than a reference, the information output unit generates information for controlling sound image localization of a sound included in the content data such that the sound included in the content data sounds to the user as if the sound surrounds the user himself/herself.

17. An information processing method executed by a computer,
the computer including outputting sound control information on a basis of an analysis result of first time-series data included in content data and an analysis result of second time-series data indicating a situation of a user,
wherein the sound control information includes information for controlling sound image localization of a voice of another user output to a user terminal used by the user or a sound included in the content data.

18. A program configured to cause a computer to function as an information processing apparatus including an information output unit configured to output sound control information on a basis of an analysis result of first time-series data included in content data and an analysis result of second time-series data indicating a situation of a user,
wherein the sound control information includes information for controlling sound image localization of a voice of another user output to a user terminal used by the user or a sound included in the content data.
